(19) United States
(12) Patent Application Publication
(10) Pub. No.: US 2007/0168711 A1
(43) Pub. Date: Jul. 19, 2007

(54) Computer-clustering system failback control method and system

(76) Inventor: Chih-Wei Chen, Taipei (TW)

Correspondence Address: PEARL COHEN ZEDEK LATZER, LLP, 1500 BROADWAY 12TH FLOOR, NEW YORK, NY, 10036, US

(21) Appl. No.: 11/239,206

(22) Filed: Sep. 30, 2005

(51) Int. Cl. G06F 11/00

(52) U.S. Cl. 714/11

(57) ABSTRACT

A computer-clustering system failback control method and system is proposed, which is designed for use with a computer-clustering system, such as a server-clustering system, for providing the server-clustering system with a failback control function which is characterized by the capability of performing an operating condition inspecting procedure on a once-failed and later resumed main server unit to check whether the main server unit after resumption and failback can maintain at normal operating condition continuously for a specified length of time; and if YES, the auto-failback function is enabled; otherwise, the auto-failback function is inhibited This feature can help avoid system performance degrade due to repeated failover and failback as in the case of prior art, and also ensure the reliability of the backup capability of the server-clustering system.

### BACKGROUND OF THE INVENTION

1. Field of the Invention

This invention relates to information technology (IT), and more particularly, to a computer-clustering system failback control method and system which is designed for use in conjunction with a computer-clustering system, such as a server-clustering system consisting of multiple server units including at least one main server unit and a redundant server unit, for providing the server-clustering system with a failback control function that is initiated in response to a failover event (i.e., the switching of active control mode from the main server unit to the redundant server unit in the event of a failure to the main server unit) to allow the switching of active control mode from the redundant server unit back to the main server unit to be carried out only when the once-failed main server unit has resumed to stable operating condition incessantly for a specified duration without repeated failure.

2. Description of Related Art

A server-clustering system is a grouping of multiple servers in a way that allows them to appear to be a single unit to client computers on a network. Clustering is a means of increasing network capacity, providing live backup in case one of the servers fails, and improving data security. In backup applications, a server-clustering system includes a main server unit and at least one redundant server unit, such that in the event of a failure to the main server unit due to power failure or operating system crash, a failover procedure is carried out to switch the active control of the server clustering system from the failed main server unit to the redundant server unit so as to allow the server-clustering system to nonetheless maintain its network data service functionality without interruption.

When the failed main server unit has resumed to normal operating condition, a failback procedure is performed to switch the active control mode from the redundant server unit back to the main server unit. Technically, the failback procedure can be carried out in two ways: manually or automatically. The manual failback method allows the network management personnel to manually operate the server-clustering system to switch the active control mode from the redundant server unit back to the main server unit; and the automatic failback method allows the server-clustering system to automatically detect whether the once-failed main server unit has resumed to normal operating condition, and if YES, switch the active control mode from the redundant server unit back to the main server unit

One drawback to the automatic failback method, however, is that if the resumed main server unit fails once again after failback, the server-clustering system will have to perform a failover-and-failback procedure once again. Therefore, if the main server unit is quite unstable in operation and repeatedly fails again and again, it will cause the server-clustering system to perform failover and failback repeatedly, thus leading to a degrade in the performance of the network data services by the server-clustering system. Moreover, this repeated failover and failback actions could also lead to a deadlock to the entire server-clustering system, causing both of the main server unit and the redundant server unit to be disabled, such that no network data services could be offered by the server-clustering system.

### SUMMARY OF THE INVENTION

It is therefore an objective of this invention to provide a computer-clustering system failback control method and system which can allow a failback procedure to be carried out only when a once-failed main server unit has resumed to stable operating condition incessantly for a specified duration without repeated failure, so as to avoid system performance degrade and ensure the reliability of the backup capability of a server clustering system.

The computer-clustering system failback control method and system according to the invention is designed for use in conjunction with a computer-clustering system, such as a server-clustering system consisting of multiple server units including at least one main server unit and a redundant server unit, for providing the server-clustering system with a failback control function that is initiated in response to a failover event (i.e., the switching of active control mode from the main server unit to the redundant server unit in the event of a failure to the main server unit) to allow the switching of active control mode from the redundant server unit back to the main server unit to be carried out only when the once-failed main server unit has resumed to stable operating condition incessantly for a specified duration without repeated failure.

The computer-clustering system failback control method according to the invention comprises: (1) after the failed main computer unit has resumed to operable condition, responding to an initial after-failure resetting event to the main computer unit by inspecting whether the main computer unit is able to maintain at normal operating condition for a predefined length of time; if NO, issuing no auto-failback enable message; and whereas if YES, issuing an auto-failback enable message; (2) responding to the auto-failback enable message by switching the active control mode of the computer-clustering system from the redundant computer unit back to the main computer unit; (3) after failback is accomplished, inspecting whether the resumed main computer unit is able to maintain at normal operating condition for a predefined length of time; if NO, issuing no auto-failback inhibiting message; and whereas if YES, issuing an auto-failback inhibiting message; and (4) responding to the auto-failback inhibiting message by setting an auto-failback flag to false for the purpose of inhibiting the computer-clustering system from performing an auto-failback procedure in the next time when a failover occurs to the computer-clustering system

In terms of architecture, the computer-clustering system failback control system according to the invention comprises: (a) a main unit operating condition inspecting module, which is capable of responding to an initial after-failure resetting event to the main computer unit that is initiated after a failure has occurred to the main computer unit, by inspecting whether the main computer unit is able to maintain at normal operating condition for a predefined length of time; if NO, issuing no auto-failback enable message; and whereas if YES, issuing an auto-failback enable message; (b) an auto-failback control module, which is capable of responding to the auto-failback enable message from the main unit operating condition inspecting module by switching the active control mode of the computer-clustering system from the redundant computer unit back to the main computer unit; and after failback is accomplished, capable of activating the main unit operating condition inspecting module to inspect whether the resumed main computer unit is able to maintain at normal operating condition for a predefined length of time; if NO, issuing no auto-failback inhibiting message; and whereas if YES, issuing an auto-failback inhibiting message; and (c) an auto-failback inhibiting module, which is capable of responding to the auto-failback inhibiting message from the auto-failback control module by setting an auto-failback flag associated with the auto-failback control module to false for the purpose of inhibiting the auto-failback control module from performing an auto-failback procedure in the next time when a failover occurs to the computer-clustering system. In addition, the computer-clustering system failback control system of the invention can further optionally comprise a manual failback control module, which is capable of providing a user-operated manual failback control function to switch the active control of the computer-clustering system from the redundant computer unit back to the main computer unit after a failover.

The computer-clustering system failback control method and system according to the invention is characterized by the capability of performing an operating condition inspecting procedure on a once failed and later resumed main server unit to check whether the main server unit after resumption and failback can maintain at normal operating condition continuously for a specified length of time; and if YES, the auto-failback function is enabled; otherwise, the auto-failback function is inhibited. This feature can help avoid system performance degrade due to repeated failover and failback as in the case of prior art, and also ensure the reliability of the backup-capability of a server-clustering system

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and object-oriented component model of the computer-clustering system failback control system according to the invention.

### DETAILED DESCRIPTION OF PREFERRED EMBODIMENTS

The computer-clustering system failback control method and system according to the invention is disclosed in full details by way of preferred embodiments in the following with reference to the accompanying drawings.

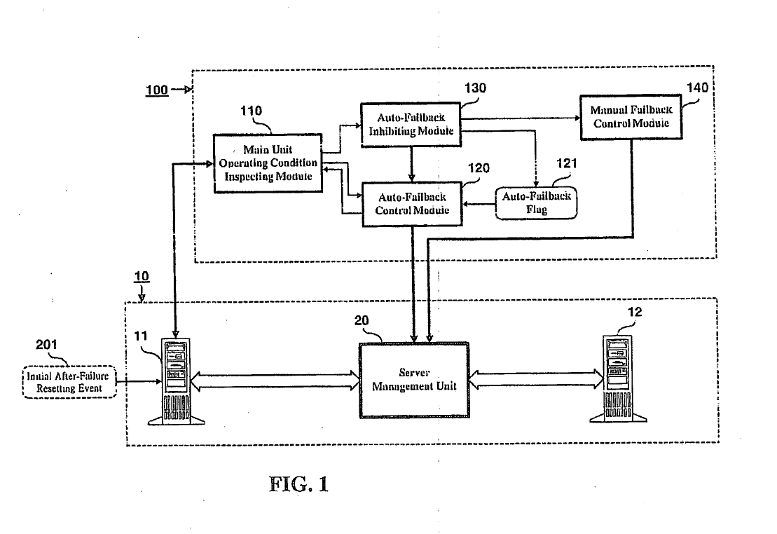

FIG. 1 is a schematic diagram showing the application architecture and modularized object-oriented component model of the computer-clustering system failback control system according to the invention (as the part enclosed in the dotted box indicated by the reference numeral 100). As shown, the computer-clustering system failback control system of the invention 100 is designed for use in conjunction with a computer-clustering system, such as a server-clustering system 10 including a main server unit 11, at least one redundant server unit 12, and a server management unit 20. During normal operation, the active control mode of the server-clustering system 10 is assigned to the main server unit 11; and in the event of a failure to the main server unit 11, such as due to power failure or operating system crash, the server management unit 20 is capable of performing a failover procedure to switch the active control mode of the server-clustering system 10 from the failed main server unit 11 to the redundant server unit 12 so as to allow the server-clustering system 10 to nonetheless maintain its network data service functionality without interruption.

In operation, the failback control system of the invention 100 is capable of providing the server-clustering system 10 with a failback control function that allows the switching of active control mode from the redundant server unit 12 back to the main server unit 11 to be carried out only when the once-failed main server unit 11 has resumed to stable operating condition incessantly for a specified duration without repeated failure.

As shown in FIG. 1, the modularized object-oriented component model of the computer-clustering system failback control system of the invention 100 comprises: (a) a main unit operating condition inspecting module 110; (b) an auto failback control module 120; and (c) an auto failback inhibiting module 130; and can further optionally comprise a manual failback control module 140.

The main unit operating condition inspecting module 110 is capable of responding to an initial after-failure resetting event 201 to the main server unit 11 that is initiated after a failure has occurred to the main server unit 11, by periodically inspecting at predefined intervals (such as every 10 seconds) whether the main server unit 11 after reset is able to maintain at normal operating condition incessantly for a predefined length of time, for example 3 minutes. If NO, the main unit operating condition inspecting module 110 will issue no auto-failback enable message; and whereas if YES, the main unit operating condition inspecting module 110 will issue an auto-failback enable message to the auto-failback control module 120. Moreover, the main unit operating condition inspecting module 110 will also be activated to perform the same operating condition inspecting procedure on the main server unit 11 after the failback is accomplished, for the purpose of continuing the inspection on the main server unit 11 to check whether it can maintain at normal operating condition for another predefined duration f time, such as 3 minutes. If NO, the main unit operating condition inspecting module 110 will issue no auto-failback inhibiting message; and whereas if YES, the main unit operating condition inspecting module 110 will issue an auto-failback inhibiting message to the auto-failback inhibiting module 130.

The auto-failback control module 120 is capable of responding to the auto-failback enable message from the main unit operating condition inspecting module 110 by switching the active control of the server-clustering system 10 from the redundant server unit 12 back to the main serves unit 11. Furthermore, after the failed main server unit 11 has been resumed normal operation, the auto-failback control module 120 is capable of issuing a main unit operating condition inspecting enable message to the main unit operating condition inspecting module 110 to activate the main unit operating condition inspecting module 110 to perform the same operating condition inspecting procedure on the main server unit 11 after failback is accomplished, so as to again inspect whether the main server unit 11 is able to maintain at normal operating condition for a predefined length of time, such as 3 minutes. If NO, the main unit operating condition inspecting module 110 will issue no auto-failback inhibiting message; and whereas if YES, the main unit operating condition inspecting module 110 will issue an auto-failback inhibiting message to the auto-failback inhibiting module 130.

The auto-failback inhibiting, module 130 is capable of responding to the auto-failback inhibiting message from the auto-failback control module 120 by setting an auto-failback flag 121 associated with the auto-failback control module 120 to [FALSE] for the purpose of inhibiting the auto-failback control module 120 to perform an auto-failback procedure in the next time when the main server unit 11 is reset after failover to the redundant server unit 12.

The manual failback control module 140 is capable of providing a user-operated manual failback control function for the user (i.e., network management personnel) to switch the active control of the server-clustering system 10 from the redundant server unit 12 back to the main server unit 11 after a failover The manual failback control module 140 is further capable of setting the auto-failback flag 121 to [TRUE] after a manual failback control procedure is completed, for the purpose of enabling the auto-failback control module 120 to be able to perform an auto-failback procedure in the next time when the main server unit 11 is reset after failover to the redundant server unit 12.

The following is a detailed description of an example of a practical application of the computer-clustering system failback control system of the invention 100 in actual operation.

Referring to FIG. 1, when the server-clustering system 10 is started to operate, the server management unit 20 will set the main server unit 11 to the active control mode and set the redundant server unit 12 to the standby mode, so as to set the main server unit 11 to provide the intended network data service functions. In addition, the failback control system of the invention 100 will initially set the auto-failback flag 121 to [TRUE].

In the event of a failure to the main server unit 11, such as due to power failure or operating system crash, the server management unit 20 will promptly perform a failover procedure for the purpose of switching the active control of the server-clustering system 10 from the failed main server unit 11 to the redundant server unit 12 so as to allow the server clustering system 10 to be nonetheless capable of maintaining its network data service functionality without interruption. At the same time, the network management personnel will perform a repair work on the failed main server unit 11.

As the cause of failure to the main server unit 11 is eliminated, the network management personnel can initiate an after-failure resetting event 201 to the main server unit 11, i.e., reset the main server unit 11 to reload operating system. As the main server unit 11 is booted and starts to operate, it will activate the failback control system of the invention 100, and the main unit operating condition inspecting module 110 is started to periodically inspect at predefined intervals (such as every 10 seconds) whether the main server unit 11 is under normal operating condition. If NO (i.e., the main server unit 11 fails again), the main unit operating condition inspecting module 110 issues an auto-failback inhibiting message to the auto-failback inhibiting module 130, causing the auto-failback inhibiting module 130 to set the auto-failback flag 121 to [FALSE] Whereas if YES (i.e., the main server unit 11 is under normal condition after 10 seconds), the inspection procedure will be repeatedly carried out to check whether the main server unit 11 is able to maintain at normal operating condition continuously for a predefined length of time, for example 3 minutes, without another failure. If NO (i.e., the main server unit 11 fails again in less than 3 minutes), the main unit operating condition inspecting module 110 will issue no auto failback enable message; and whereas if YES (i.e., the main server unit 11 has maintained at normal operating condition for 3 minutes), the main unit operating condition inspecting module 110 will issue an auto-failback enable message to the auto-failback control module 120, activating the auto-failback control module 120 to perform an auto-failback procedure to switch the active control of the server-clustering system 10 from the redundant server unit 12 back to the main server unit 11, i.e., the main server unit 11 is again set to the active control mode, while the redundant server unit 12 is set back to the standby mode

As the main server unit 11 has resumed to its active control mode, the main unit operating condition inspecting module 110 is once again activated to perform the same operating condition inspecting procedure on the main server unit 11, i.e., inspect at predefined intervals of 10 seconds whether the main server unit 11 is under normal operating condition. If NO (i.e., the main server unit 11 fails again), the main unit operating condition inspecting module 110 issues an auto-failback inhibiting message to the auto-failback inhibiting module 130, causing the auto-failback inhibiting module 130 to set the auto-failback flag 121 to [FALSE] Whereas if YES (i.e., the main server unit 11 is under normal condition after 10 seconds), the inspection procedure will be repeatedly carried out to check whether the main server unit 11 is able to maintain at normal operating condition continuously for a predefined time length of 3 minutes without another failure. If NO (i.e., the main server unit 11 fails again in less than 3 minutes), the main unit operating condition inspecting module 110 will issue no auto-failback enable message; and whereas if YES (i.e., the main server unit 11 has maintained at normal operating condition for 3 minutes), the procedure is ended

When the auto failback flag 121 is set to [FALSE], it indicates that the once-failed main server unit 11 after reset is still under unstable operating condition, and so that it will inhibit the auto-failback control module 120 to perform an auto-failback procedure after failover Under this situation, if the network management personnel want to switch the active control mode from the redundant server unit 12 back to the main server unit 11, then the network management personnel can activate the manual failback control module 140 to manually perform a failback procedure. After this manually-controlled failback procedure is completed, the manual failback control module 140 will set the auto-failback flag 121 to [TRUE], for the purpose of enabling the auto-failback control module 120 to be able to perform an auto-failback procedure in the next time when the main server unit 11 is reset after failover to the redundant server unit 12.

In conclusion, the invention provides a computer-clustering system failback control method and system for use with a computer clustering system, such as a server-clustering system for providing the server-clustering system with a failback control function, and which is characterized by the capability of performing an operating condition inspecting procedure on a once failed and later resumed main server unit to check whether the main server unit after resumption and failback can maintain at normal operating condition continuously for a specified length of time; and if YES, the auto-failback function is enabled; otherwise, the auto-failback function is inhibited. This feature can help avoid system performance degrade due to repeated failover and failback as in the case of prior art, and also ensure the reliability of the backup capability of a server-clustering system. The invention is therefore more advantageous to use than the prior art

The invention has been described using exemplary preferred embodiments However, it is to be understood that the scope of the invention is not limited to the disclosed embodiments On the contrary, it is intended to cover various modifications and similar arrangements. The scope of the claims, therefore, should be accorded the broadest interpretation so as to encompass all such modifications and similar arrangements.

1. A computer-clustering system failback control method for use on a computer clustering system that includes a main computer unit and at least one redundant computer unit for providing the computer-clustering system with a failback control function in response to a failover from the main computer unit to the redundant computer unit in the event of a failure to the main computer unit;
the computer-clustering system failback control method comprising:
after the failed main computer unit has resumed to operable condition, responding to an initial after-failure resetting event to the main computer unit by inspecting whether the main computer unit is able to maintain at normal operating condition for a predefined length of time; if NO, issuing no auto-failback enable message; and whereas if YES, issuing an auto-failback enable message;
responding to the auto-failback enable message by performing an auto-failback procedure to switch the active control mode of the computer-clustering system from the redundant computer unit back to the main computer unit;
after failback is accomplished, inspecting whether the resumed main computer unit is able to maintain at normal operating condition for a predefined length of time; if NO, issuing an auto-failback inhibiting message to inhibit the computer-clustering system from performing the auto-failback procedure the next time when a failover occurs to the computer-clustering system; and whereas if YES, issuing no auto-failback inhibiting message;
responding to the auto-failback inhibiting message by setting an auto-failback flag to false for the purpose of inhibiting the computer-clustering system from performing an the auto-failback procedure in the next time when a failover occurs to the computer-clustering system.

2. The computer-clustering system failback control method of claim 1, wherein the computer-clustering system is a server-clustering system.

3. The computer-clustering system failback control method of claim 1, further comprising:
a manual failback control procedure for providing a user-operated manual failback control function to switch the active control of the computer-clustering system from the redundant computer unit back to the main computer unit after a failover.

4. The computer-clustering system failback control method of claim 3, wherein the manual failback control procedure further includes a step of setting the auto-failback flag to true after manual failback is accomplished.

5. A computer-clustering system failback control system for use with a computer clustering system that includes a main computer unit and at least one redundant computer unit for providing the computer-clustering system with a failback control function in response to a failover from the main computer unit to the redundant computer unit in the event of a failure to the main computer unit;
the computer-clustering system failback control system comprising:
a main unit operating condition inspecting module, which is capable of responding to an initial after-failure resetting event to the main computer unit that is initiated after a failure has occurred to the main computer unit, by inspecting whether the main computer unit is able to maintain at normal operating condition for a predefined length of time; if NO, issuing no auto-failback enable message; and whereas if YES, issuing an auto-failback enable message;
an auto-failback control module, which is capable of responding to the auto-failback enable message from the main unit operating condition inspecting module by performing the auto-failback procedure to switch the active control mode of the computer-clustering system from the redundant computer unit back to the main computer unit; and after failback is accomplished, capable of activating the main unit operating condition inspecting module to inspect whether the resumed main computer unit is able to maintain at normal operating condition for a predefined length of time; if NO, issuing an auto-failback inhibiting message; and whereas if YES, issuing no auto-failback inhibiting message;
an auto-failback inhibiting module, which is capable of responding to the auto-failback inhibiting message from the auto-failback control module by setting an auto-failback flag associated with the auto-failback control module to false for the purpose of inhibiting the auto-failback control module from performing the auto-failback procedure in the next time when a failover occurs to the computer-clustering system.

6. The computer-clustering system failback control system of claim 5, wherein the computer-clustering system is a server-clustering system.

7. The computer-clustering system failback control system of claim 5, further comprising:
a manual failback control procedure for providing a user-operated manual failback control function to switch the active control of the computer-clustering system from the redundant computer unit back to the main computer unit after a failover.

8. The computer-clustering system failback control system of claim 7, wherein the manual failback control module is further capable of setting the auto-failback flag to true after a manual failback control procedure is completed.
